(19) United States
(12) Patent Application Publication
(10) Pub. No.: US 2014/0152797 A1
(43) Pub. Date: Jun. 5, 2014

(54) CONFOCAL OPTICAL INSPECTION APPARATUS AND CONFOCAL OPTICAL INSPECTION METHOD

(71) Applicant: SAMSUNG ELECTRONICS CO., LTD., Suwon-si (KR)

(72) Inventors: Togashi MITSUHIRO, Yokohama (JP); Numata MITSUNORI, Yokohama (JP); Ueyama SHINJI, Yokohama (JP)

(73) Assignee: SAMSUNG ELECTRONICS CO., LTD., Suwon-si (KR)

(21) Appl. No.: 14/096,642

(22) Filed: Dec. 4, 2013

(30) Foreign Application Priority Data
Dec. 4, 2012 (JP) 2012-265692
Nov. 21, 2013 (KR) 10-2013-0142337

(51) Int. Cl. G02B 21/00; G01N 21/88

(52) U.S. Cl. CPC G02B 21/0084; G01N 21/8806
USPC 348/79

(57) ABSTRACT

The confocal optical inspection apparatus that acquires a confocal image of an object and inspects the object includes a light source that emits illumination light; a first opening member that divides the illumination light emitted from the light source into illumination light beams, the first opening member having openings; an imaging device that acquires an image according to the respective illumination light beams reflected by the object; and an information processor that acquires a corrected confocal image in which distortion of an optical transmission path of the confocal optical inspection apparatus is removed from a time delayed integration (TDI) image obtained by a TDI operation of the imaging device, using a pre-measured point spread function (PSF) indicating optical characteristics of the confocal optical inspection apparatus.

### CROSS-REFERENCE TO RELATED APPLICATIONS

This application claims priority from Japanese Patent Application No. 2012-265692, filed on Dec. 4, 2012, in the Japanese Patent Office and from Korean Patent Application No. 10-2013-0142337, filed on Nov. 21, 2013, in the Korean Intellectual Property Office, the disclosures of which are incorporated by reference herein in their entireties.

### BACKGROUND

1. Field

Apparatuses, devices, and articles of manufacture consistent with the present disclosure relate to a confocal optical inspection apparatus that inspects an object using a confocal-type optical system, and a confocal optical inspection method.

2. Description of the Related Art

A confocal microscope may obtain a high resolution image of an object using a confocal optical system.

In a confocal microscope, when an observation region of an object is far larger than one image shown by an object lens, a process such as imaging of a series of images is required. For example, Japanese Patent No. 3970998 discloses a confocal microscope with a large observation region.

However, there is a disadvantage in that distortion may occur in the optical system. When distortion occurs in the optical system, the resolution of an obtained image may be decreased. In the above-described confocal microscope of Japanese Patent No. 3970998, the distortion of the optical system is not considered.

### SUMMARY

It is an aspect of the inventive concept to provide a new and advanced confocal optical inspection apparatus capable of acquiring information on an object with a higher level of accuracy in consideration of distortion of an optical system, and a confocal optical inspection method thereof.

According to an aspect of an exemplary embodiment, there is provided a confocal optical inspection apparatus that acquires a confocal image of an object and inspects the object, the confocal optical inspection apparatus including a light source that is configured to emit illumination light; a first opening member that is configured to divide the illumination light emitted from the light source into a plurality of illumination light beams, the first opening member having a plurality of openings; an imaging device that is configured to acquire an image according to the respective illumination light beams reflected by the object; and an information processor that is configured to acquire a corrected confocal image in which distortion of an optical transmission path of the confocal optical inspection apparatus is removed from a time delayed integration (TDI) image obtained by a TDI operation of the imaging device, using a pre-measured point spread function (PSF) indicating optical characteristics of the confocal optical inspection apparatus.

The PSF, the TDI image, and the corrected confocal image of the object which is an original image may satisfy

g(x)=Σᵢ^{N}p(x−xᵢ)f(xᵢ) (FORMULA 1)

wherein, g(x) denotes the TDI image, p(x) denotes the PSF, and f(x) denotes the corrected confocal image, x denotes a pixel position of the TDI image, and i denotes a value of 0 to N. The information processor may calculate an inverse matrix of the PSF to acquire the corrected confocal image which is an estimated image of the confocal image.

The PSF may be acquired by imaging the object in a state where the object is stopped.

The openings of the first opening member may be formed in a lattice shape such that each opening has a shift amount in a first direction which is a scanning direction of the object and a shift amount in a second direction perpendicular to the scanning direction, and the shift amount of the opening in the second direction may be an integer multiple of a pixel size of the TDI image.

Each of the openings of the first opening member may be, for example, a pinhole.

The confocal optical inspection apparatus may further include a second opening member having a plurality of openings transmitting reflected light from the object, and each of the openings of the second opening member may be formed such that a length of the opening in an insertion and extraction direction, in which the second opening member is inserted into and extracted from the confocal optical inspection apparatus, is larger than a length of the opening in a direction perpendicular to the insertion and extraction direction.

The second opening member may be installed in the confocal optical inspection apparatus so as to be inserted or extracted in the second direction perpendicular to the scanning direction of the object.

According to another aspect of an exemplary embodiment, there is provided a confocal optical inspection method of acquiring a confocal image of an object to inspect the object. The confocal optical inspection method includes acquiring a point spread function (PSF) indicating characteristics of an optical system of a confocal optical inspection apparatus; and acquiring a corrected confocal image in which distortion of an optical transmission path of the confocal optical inspection apparatus is removed from a time delayed integration (TDI) image obtained by a TDI operation of an imaging unit of the confocal optical inspection apparatus, by using the PSF.

According to another aspect of an exemplary embodiment, there is provided a confocal optical inspection apparatus comprising a time delay integration (TDI) camera that acquires an image from light reflected by an object; a light source that emits illumination light; a pinhole member that is provided in an optical transmission path from the light source to the TDI camera, and comprises a plurality of pinholes that divide the illumination light into a plurality of illumination light beams for illuminating the object; and an information processor that is configured to acquire a point spread function (PSF) indicating an optical characteristic of the optical transmission path from the image acquired by the TDI camera when the object is stationary, produces, using the acquired PSF, a corrected confocal image in which distortion from the optical transmission path is removed from a TDI image acquired by a TDI operation of the TDI camera when the object is moving, and outputs the corrected confocal image

### BRIEF DESCRIPTION OF THE DRAWINGS

Exemplary embodiments will be more clearly understood from the following detailed description taken in conjunction with the accompanying drawings in which:

FIG. 1 is a schematic diagram illustrating a configuration of a confocal optical inspection apparatus according to an exemplary embodiment;

FIG. 2 is a partially enlarged cross-sectional view of a microlens array and a pinhole member of the confocal optical inspection apparatus of FIG. 1, according to an exemplary embodiment;

FIG. 3 is a plan view illustrating a configuration example of the pinhole member of FIG. 2, according to an exemplary embodiment;

FIG. 4 is an image showing an example of a spot image in an imaging surface of a time delayed integration (TDI) camera;

FIG. 5 is a diagram illustrating an image of an integration result (one-dimensional) obtained through the TDI camera;

FIG. 6 is a block diagram illustrating a functional configuration of an information processor of the confocal optical inspection apparatus of FIG. 1, according to an exemplary embodiment;

FIG. 7 is a flowchart illustrating a correction process of a TDI image, according to an exemplary embodiment; and

FIG. 8 is a plan view illustrating an opening member according to an exemplary embodiment.

### DETAILED DESCRIPTION

Hereinafter, exemplary embodiments will be described in detail with reference to the attached drawings. The same reference numerals in the drawings denote the same element, and a repeated description will be omitted.

<1. Configuration of Confocal Optical Inspection Apparatus>

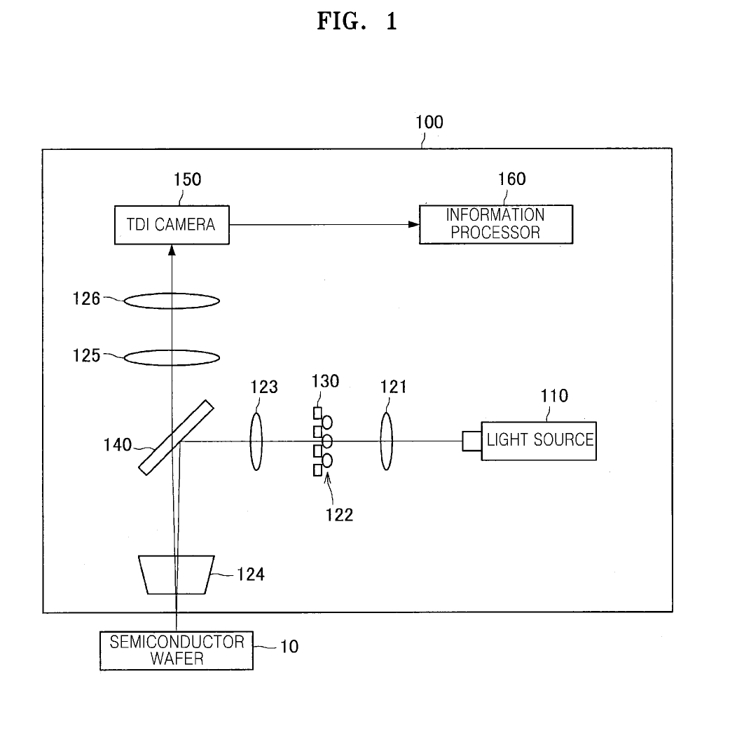

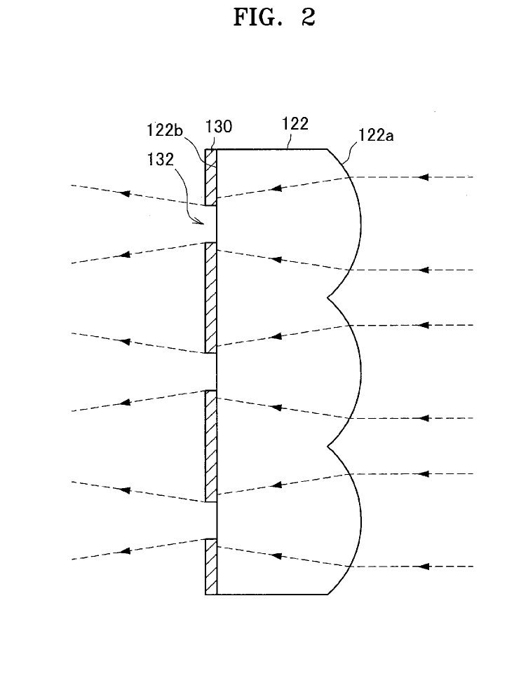

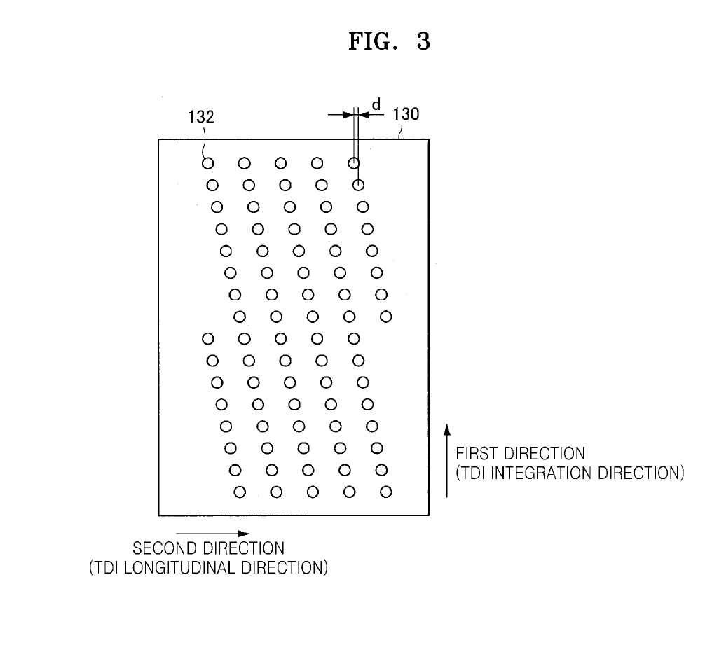

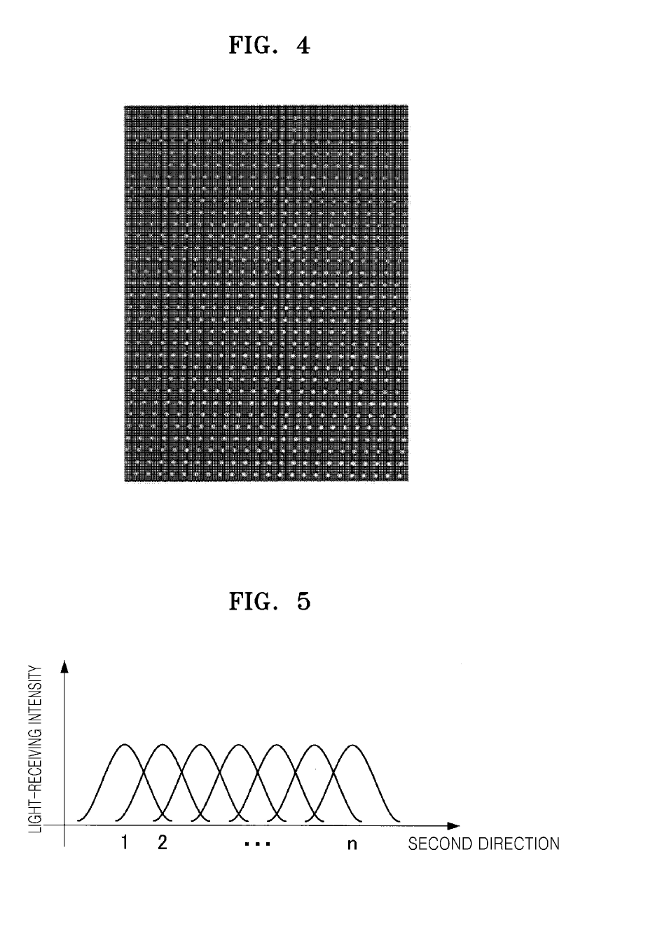

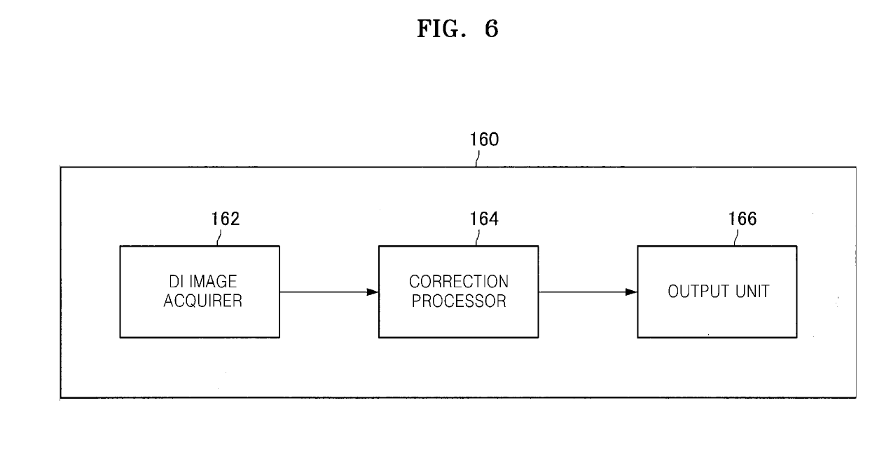

First, a configuration of a confocal optical inspection apparatus according to an exemplary embodiment will be described with reference to the drawings. FIG. 1 is a schematic diagram illustrating a configuration of a confocal optical inspection apparatus according to an exemplary embodiment. FIG. 2 is a partially enlarged cross-sectional view of a microlens array and a pinhole member of the confocal optical inspection apparatus of FIG. 1, according to an exemplary embodiment. FIG. 3 is a plan view illustrating a configuration example of the pinhole member according to an exemplary embodiment. FIG. 4 is an image showing an example of a spot image in an imaging surface of a time delayed integration (TDI) camera of the confocal optical inspection apparatus of FIG. 1. FIG. 5 is a diagram illustrating an image of an integration result (one-dimensional) obtained through the TDI camera. FIG. 6 is a block diagram illustrating a functional configuration of an information processing unit of the confocal optical inspection apparatus of FIG. 1, according to an exemplary embodiment.

The confocal optical inspection apparatus according to an exemplary embodiment is an apparatus for optically inspecting a defect of an object such as a semiconductor wafer by using a confocal optical system. The confocal optical inspection apparatus uses a moving stage having an object loaded thereon and moving on a plane so that an object having a wide inspection region, such as the semiconductor wafer, may be inspected with respect to a range capable of one imaging operation being performed thereon.

The confocal optical inspection apparatus acquires an image of the object loaded on the moving stage which is formed by the confocal optical system, by using a time delay integration (TDI) camera, and acquires shape information of the object as a TDI image.

As illustrated in FIG. 1, a confocal optical inspection apparatus 100 comprises a light source 110, relay lenses 121, 123, 125, 126, a beam splitter 140, a microlens array 122, an object lens 124, a time delay integration (TDI) camera 150, and an information processor 160. In the confocal optical inspection apparatus 100, light with which an object is irradiated is emitted from the light source 110, a semiconductor wafer 10 as the object is irradiated with the light, and the light reflected by the semiconductor wafer 10 is received by the TDI camera 150 which is an example of an imaging device, and thus the shape information of the semiconductor wafer 10 is acquired. Light transmission between the light source 110, the semiconductor wafer 10, and the TDI camera 150 is performed by the relay lenses 121, 123, 125, and 126, the microlens array 122, the object lens 124, and the beam splitter 140. In addition, the microlens array 122 comprises a pinhole member 130 provided on the emission surface side of light in the microlens array 122. Thus, light proceeds along an optical transmission path shown by the arrow in FIG. 1.

The light source 110 emits a laser beam. The emitted laser beam is incident on the microlens array 122 through the relay lens 121. The microlens array 122 is a member in which a plurality of microlenses are arranged in a lattice shape. For example, as illustrated in FIG. 2, a plurality of microlenses having an incident surface 122a being a curved surface and an emission surface 122b being a plane are arranged in the microlens array 122. The pinhole member 130 is provided on the emission surface 122b side of the microlens array 122.

A plurality of pinholes 132 are formed in the pinhole member 130. For example, as illustrated in FIG. 3, each of the pinholes 132 of the pinhole member 130 is formed to have a shift amount in a first direction which is a scanning direction of an object and a shift amount in a second direction perpendicular to the scanning direction. In addition, the scanning direction of the object which is the first direction corresponds to a TDI integration direction in which the TDI camera 150 to be described in detail later integrates spot light beams condensed in the TDI camera 150. In addition, the second direction is also referred to as a TDI longitudinal direction. Here, a shift amount d in the second direction from among the shift amounts in the respective directions may be set as an integer multiple of a pixel size of the TDI image. Thus, a calculation process for acquiring a confocal image from which optical system transmission distortion, which will be described later, is removed can be effectively performed, thereby increasing a process speed.

In the confocal optical inspection apparatus 100, the microlens array 122 may be omitted. That is, alternatively, the pinhole member 130 may be provided without the microlens array 122. However, in the current exemplary embodiment, the microlens array 122 is provided to ensure the amount of laser beams from the light source 110. That is, the microlens array 122 helps to focus the light from the light source 110 on the pinholes 132 as shown in FIG. 2. The microlens array 122 and the pinhole member 130 are arranged such that the respective condensing positions of the microlenses of the microlens array 122 correspond to the pinholes 132 formed in the pinhole member 130.

A laser beam passing through the pinhole 132 is incident on the beam splitter 140 through the relay lens 123. For example, a non-polarized beam splitter may be used as the beam splitter 140. The beam splitter 140 reflects the laser beam incident from the pinhole member 130 side, toward the object lens 124 side. The laser beam reflected by the beam splitter 140 is condensed by the object lens 124, and then the surface of the semiconductor wafer 10 is irradiated with the laser beam.

The laser beam with which the surface of the semiconductor wafer 10 is irradiated is reflected by the surface, passes through the object lens 124, and is incident on the beam splitter 140. The beam splitter 140 guides the laser beam incident from the semiconductor wafer 10 side toward the TDI camera 150 side. The reflected light passing through the beam splitter 140 is condensed onto the TDI camera 150 by the relay lenses 125 and 126.

The TDI camera 150 acquires a TDI image on the basis of the intensities of the respective condensed spot beams. The TDI camera 150 is configured such that a plurality of line units having imaging devices being arranged in a row are arranged in a direction perpendicular to an arrangement direction of the imaging devices. When the object loaded on the moving stage is imaged without moving the moving stage, an image having a plurality of spot images is formed on the imaging surface of the TDI camera 150 as illustrated in FIG. 4. The confocal image acquired without moving the object is an image including distortion of an optical transmission path of the confocal optical system, and shows a point spread function (PSF) at each position.

When the whole surface of the object is inspected, the surface of the object is sequentially imaged using the TDI camera 150 while moving the object by moving the moving stage. At this time, the TDI camera 150 integrates an image obtained by focusing the spot beams, lined up in the second direction perpendicular to the scanning direction of the object, on the imaging surface to acquire a TDI image showing the whole object.

That is, in each line unit of the TDI camera 150, an image in which the spot beams lined up in the second direction overlap each other is acquired as illustrated in FIG. 5. With respect to such imaging, first, the TDI camera 150 transmits imaging obtained in the line unit of a first column to the line unit of a second column, adds the imaging obtained in the line unit of the second column to the imaging transmitted from the first column, accumulates the added imaging, and transmits the added imaging to the line unit of a third column, and so on. Similarly, the TDI camera 150 adds imaging obtained in the line unit of an n-th column to the imaging accumulated up to an (n−1)-the column, and transmits the added imaging to an (n+1)-th column. The TDI image which is finally obtained through such an integration process is changed to a high sensitivity image having a sufficient brightness. The TDI camera 150 outputs the TDI image obtained by integrating the imaging obtained in the respective line units in the scanning direction (first direction) to the information processor 160.

The information processor 160 performs a process of acquiring an original image acquired by the TDI camera 150, and removing distortion of an optical system transmission path from the TDI image. As illustrated in FIG. 6, the information processor 160 includes a TDI image acquirer 162, a correction processor 164, and an output unit 166. The information processor 160 may be implemented using at least one central processing unit (CPU) or at least one microprocessor, operating in conjunction with one or more memories.

The TDI image acquirer 162 receives the TDI image output from the TDI camera 150 and outputs the received TDI image to the correction processor 164. The correction processor 164 acquires the original image containing the distortion of the optical system transmission path from the TDI image acquirer 162, and removes the distortion by using a point spread function (PSF). The PSF is a function indicating characteristics of the optical transmission path. The correction processor 164 acquires the original image from the TDI image acquired by the TDI camera 150, and removes the distortion of the optical system transmission path through calculation to correct the TDI image. A correction process performed by the correction processor 164 will be described later in detail. The correction processor 164 outputs the corrected image to the output unit 166. The output unit 166 appropriately outputs the corrected image to a display device (not shown) or a storage device (not shown) for storing information, or the like.

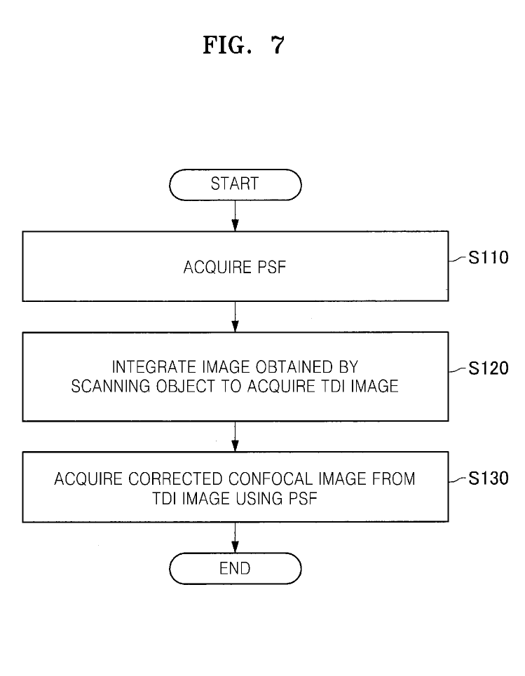

A configuration of the confocal optical inspection apparatus 100 according to an exemplary embodiment has been described above. In the confocal optical inspection apparatus 100, the information processor 160 performs correction on the TDI image acquired by the TDI camera 150 for removing the distortion of the optical transmission path, and thus a clearer image of an object may be acquired, thereby preventing performance degradation due to variations in an optical system. Hereinafter, a correction process of a TDI image using the information processor 160 of the confocal optical inspection apparatus 100 will be described with reference to FIG. 7, which is a flowchart illustrating the correction process of the TDI image according to an exemplary embodiment.

<2. Correction Process of TDI Image>

As illustrated in FIG. 7, a PSF indicating characteristics of an optical transmission path of the confocal optical inspection apparatus 100 is acquired before the start of the inspection of an object (operation S110). As described above, the PSF is a function indicating characteristics of an optical system transmission path. In operation S110, the pinhole member 130 is set (see detailed description below) so that a spot size on the surface of an object sample loaded on the moving stage becomes a size of a diffraction limit in a state where the moving stage is stopped, to acquire an image by using the TDI camera 150. The TDI image obtained at this time is, for example, the spot image illustrated in FIG. 4, and this spot image is a PSF indicating characteristics of the optical system transmission path of the confocal optical inspection apparatus 100. The acquired PSF is stored in a storage unit (not shown) which the correction processor 164 is capable of referring to.

The confocal optical inspection apparatus 100 integrates an image obtained by scanning an object to acquire a TDI image (operation S120). The TDI image is acquired by the TDI camera 150 and is input to the TDI image acquirer 162 of the information processor 160. The TDI image acquirer 162 outputs the input TDI image to the correction processor 164.

The correction processor 164 receiving the TDI image generates a corrected image in which distortion of the optical transmission path is removed from the TDI image, using the PSF acquired in operation S110 (operation S130). In order to generate the corrected image, the correction processor 164 uses a FORMULA 1 below describing a relationship among the TDI image g(x), the PSF p(x), and an image f(x) of an object in which distortion of an optical transmission path is not removed. In FORMULA 1 below, x denotes a pixel position of the TDI image, and i has a value of 0 to N. Here, x0 to xN may have a discrete value.

g(x)=Σᵢ^{N}p(x−xᵢ)f(xᵢ) (FORMULA 1)

Here, in the confocal optical system, coherent beams (laser beams) are used, and the coherent beams are focused by being separated from each other so as not to overlap each other at the same time. Accordingly, in time delay integration, a light intensity is integrated, and thus it is not necessary to consider a phase as in focusing of an ordinary coherent beam. That is, a light intensity is considered.

In the confocal optical inspection apparatus 100 according to an exemplary embodiment, the pinholes 132 of the pinhole member 130 are formed to be shifted at intervals in the second direction (TDI longitudinal direction) in each column as illustrated in FIG. 3. A shift amount d may be set to be an integer multiple of a pixel size of the TDI image in order to effectively perform the calculation of FORMULA 1 described above. For example, when the shift amount d is set to be three times the pixel size, x0 is set to a 0-th pixel value in the first direction (TDI integration direction), x1 is set to a third pixel value in the first direction, x2 is set to a sixth pixel value in the second direction, and so on. Meanwhile, the second direction is a general movement direction for each pixel. For example, lighting may be blinked so as to acquire data with respect to every other pixel. In this case, the above-described operation is used.

When FORMULA 1 is expressed in a matrix form, FORMULA 2 below is obtained. In addition, the relation of p(0)=1 is established.

$$( \begin{matrix}g ( {x}_{0} ) \\ ⋮ \\ \\ g ( {x}_{N} )\end{matrix} ) = ( \begin{matrix}1 & p ( {x}_{0} - {x}_{1} ) & … & p ( {x}_{0} - {x}_{N} ) \\ p ( {x}_{1} - {x}_{0} ) & 1 & & ⋮ \\ ⋮ & & ⋱ & \\ p ( {x}_{N} - {x}_{0} ) & … & & 1\end{matrix} ) ( \begin{matrix}f ( {x}_{0} ) \\ ⋮ \\ \\ f ( {x}_{N} )\end{matrix} ) \qquad ( FORMULA 2 )$$

In FORMULA 2, p(x) is acquired in operation S110, and thus p(x) is already known. In addition, g(x) is acquired in operation S120, and thus g(x) is already known. Accordingly, when an inverse matrix of a PSF is calculated, an image (observation object image) having no distortion due to an optical transmission path may be acquired. That is, in FORMULA 2, an image f(x) at the time of taking of the matrix of the PSF is a corrected confocal image, and is expressed as FORMULA 3 below.

$$( \begin{matrix}\hat{f} ( {x}_{0} ) \\ ⋮ \\ \\ \hat{f} ( {x}_{N} )\end{matrix} ) = {( \begin{matrix}1 & p ( {x}_{0} - {x}_{1} ) & … & p ( {x}_{0} - {x}_{N} ) \\ p ( {x}_{1} - {x}_{0} ) & 1 & & ⋮ \\ ⋮ & & ⋱ & \\ p ( {x}_{N} - {x}_{0} ) & … & & 1\end{matrix} )}^{- 1} ( \begin{matrix}g ( {x}_{0} ) \\ ⋮ \\ \\ g ( {x}_{N} )\end{matrix} ) \qquad ( FORMULA 3 )$$

Here, in FORMULA 3 described above, for the purpose of simplification, the PSF (p(x)) is set to be a single function. However, generation aberration actually varies depending on the position of an image, and thus the PSF also varies depending on an imaging position. For example, as a distance from an optical axis increases, aberration such as comatic aberration or astigmatism tends to increase. In addition, when an image surface is curved, the amounts of defocusing differ between positions on the optical axis and outside of the optical axis. All of these result in a variation in PSF. However, in the confocal optical inspection apparatus 100 according to the current exemplary embodiment, for example, a PSF at a real position as illustrated in FIG. 4 is acquired by the process of operation S110. The use of such a PSF at the real position may prevent performance degradation due to variations in the optical system, and thus a corrected confocal image restored from the original image may be acquired with a high level of accuracy.

When the correction processor 164 acquires the corrected confocal image which is the image in which the distortion of the optical transmission path is removed from the TDI image in operation S130, the correction processor 164 outputs the corrected confocal image to the output unit 166. The output unit 166 outputs the corrected confocal image to an external device or the like.

In the above, the correction process of the TDI image through the confocal optical inspection apparatus 100 according to an exemplary embodiment has been described. In the above description, noise due to vibration at the time of scanning of a sensor or an object has not been considered. However, when noise w(x) is considered, FORMULA 1 and FORMULA 2 described above are changed to FORMULA 4 and FORMULA 5 below.

$$\begin{matrix} g ( x ) = {\sum }_{i}^{N} p ( x - {x}_{i} ) f ( {x}_{i} ) + w ( {x}_{i} ) & ( FORMULA 4 ) \\ ( \begin{matrix}g ( {x}_{0} ) \\ ⋮ \\ \\ g ( {x}_{N} )\end{matrix} ) = ( \begin{matrix}1 & p ( {x}_{0} - {x}_{1} ) & … & p ( {x}_{0} - {x}_{N} ) \\ p ( {x}_{1} - {x}_{0} ) & 1 & & ⋮ \\ ⋮ & & ⋱ & \\ p ( {x}_{N} - {x}_{0} ) & … & & 1\end{matrix} ) ( \begin{matrix}f ( {x}_{0} ) \\ ⋮ \\ \\ f ( {x}_{N} )\end{matrix} ) + ( \begin{matrix}w ( {x}_{0} ) \\ ⋮ \\ \\ w ( {x}_{N} )\end{matrix} ) & ( FORMULA 5 )\end{matrix}$$

In addition, the corrected confocal image which is an estimated amount of the original image may be expressed as FORMULA 6 below.

$$\begin{matrix} & ( FORMULA 6 ) \\ \begin{matrix}( \begin{matrix}\hat{f} ( {x}_{0} ) \\ ⋮ \\ \\ \hat{f} ( {x}_{N} )\end{matrix} ) = {( \begin{matrix}1 & p ( {x}_{0} - {x}_{1} ) & … & p ( {x}_{0} - {x}_{N} ) \\ p ( {x}_{1} - {x}_{0} ) & 1 & & ⋮ \\ ⋮ & & ⋱ & \\ p ( {x}_{N} - {x}_{0} ) & … & & 1\end{matrix} )}^{- 1} ( \begin{matrix}g ( {x}_{0} ) \\ ⋮ \\ \\ g ( {x}_{N} )\end{matrix} ) \\ = ( \begin{matrix}f ( {x}_{0} ) \\ ⋮ \\ \\ f ( {x}_{N} )\end{matrix} ) + {( \begin{matrix}1 & p ( {x}_{0} - {x}_{1} ) & … & p ( {x}_{0} - {x}_{N} ) \\ p ( {x}_{1} - {x}_{0} ) & 1 & & ⋮ \\ ⋮ & & ⋱ & \\ P ( {x}_{N} - {x}_{0} ) & … & & 1\end{matrix} )}^{- 1} \\ ( \begin{matrix}w ( {x}_{0 } ) \\ ⋮ \\ \\ w ( {x}_{N} )\end{matrix} )\end{matrix} & \end{matrix}$$

In FORMULA 6, a PSF (p(x)) is already known, and when a second member of the right side of the FORMULA 6 shown above is 0, an image may be estimated completely uniquely. However, in a real image, the second member of the right side of the FORMULA 6 shown above may be expanded. In this case, the influence of noise may be suppressed using, for example, a Wiener filter. Although the correction process of the TDI image has been described as a one-dimensional process, the correction process may be expanded to be a two-dimensional process.

<3. Installation of Opening Member on the Light-Receiving Side>

In the confocal optical inspection apparatus 100 according to the current exemplary embodiment, as illustrated in FIG. 1, the pinhole member 130 illustrated in FIG. 3 is provided on the lighting side where the light source 110 is disposed. Alternatively, an opening member transmitting each spot beam may be provided in the confocal optical inspection apparatus 100 before the spot beam reflected by an object is focused on the TDI camera 150 (that is, on the light-receiving side). That is, the pinhole member 130 may be provided on the lighting side, and the opening member may be provided on the light-receiving side. Thus, a diffraction pattern of the spot beam reflected by the object may be cut, and thus a clearer TDI image may be acquired.

In the confocal optical system having the opening member, when positional displacement occurs between the pinhole member on the lighting side 130 and the opening member on the light-receiving side, performance degradation occurs. Although depending on the size of the openings formed in each of the pinhole member and opening member, position adjustment between the pinhole member on the lighting side 130 and the opening member on the light-receiving side should have an accuracy of several μm. When the opening member is fixedly used, accuracy of positions of these may be ensured through initial adjustment. Meanwhile, when a related art optical system and the confocal optical system are switched with each other, the light-receiving side optical system may be used in common. Accordingly, switching adjustment is performed by the opening member on the light-receiving side being inserted or extracted, and thus it becomes advantageous to ensure the accuracy every time the insertion or extraction of the opening member is performed.

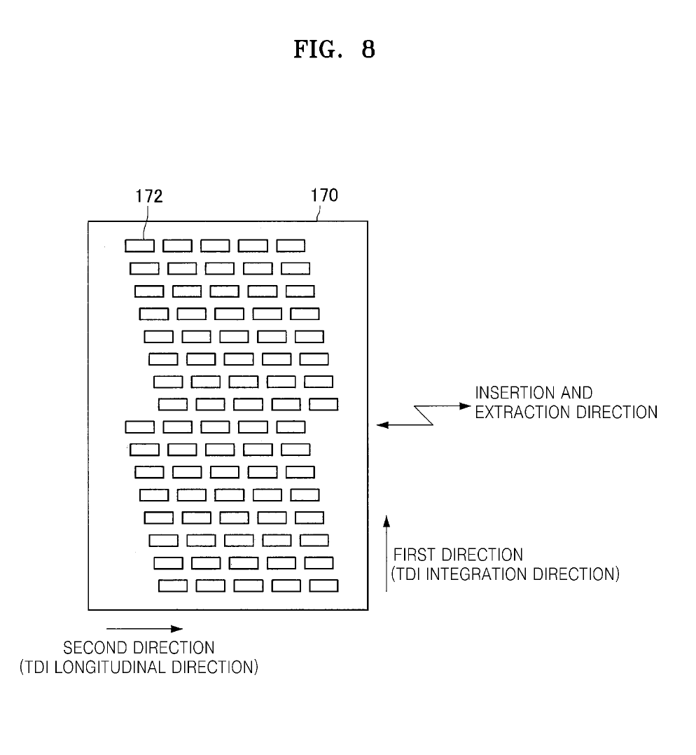

Consequently, in the confocal optical inspection apparatus 100 according to the current exemplary embodiment, for example, an opening member 170 having a plurality of slits formed therein as illustrated in FIG. 8 may be provided on the light-receiving side, and thus the positional accuracy with the pinhole member 130 is ensured at the time of switching of the optical system. In the opening member 170 illustrated in FIG. 8, a plurality of slits 172 are formed to correspond to the arrangement position of the respective imaging devices of the TDI camera 150.

It is noted that a plurality of slits 172 is shown in FIG. 8. Different geometries of openings may alternatively be provided. Slits provide certain advantages over other geometries. The slits 172 are formed to extend lengthwise in the second direction (TDI longitudinal direction) which is perpendicular to the scanning direction. This is to facilitate insertion or extraction of the opening member 170 in the second direction. The opening member 170 is moved in an insertion and extraction direction, and thus the amount of positional displacement in the second direction, which is the insertion and extraction direction, is more likely to be increased than the amount of positional displacement in the first direction. If the opening formed in the opening member on the light-receiving side has a circular shape or a square shape like the pinhole member 130, the same degree of positional accuracy is required in both the first direction and the second direction. Consequently, in the opening member 170 of FIG. 8, the slits 172 extending lengthwise in the insertion and extraction direction are advantageously formed, and thus the positional accuracy in the insertion and extraction direction is mitigated. When the positional accuracy in one direction may be mitigated, the opening member on the light-receiving side may be easily switched by an insertion and extraction mechanism of the opening member guided along the one direction.

In the confocal optical inspection apparatus 100 according to the current exemplary embodiment, the original image in which the distortion of the optical transmission path is removed using a PSF may be acquired through the above-described correction process of the TDI image. Accordingly, when an image of an object is acquired using TDI, imaging in the second direction which is the TDI longitudinal direction is integrated. Thus, the image in the second direction is not divided in principle, but the PSF is acquired in a state where the opening member 170 is provided, thereby allowing the original image to be acquired as described above even if the positional accuracy in the second direction is mitigated. In addition, the opening portion of the opening member on the light-receiving side may have a large size to the extent that expansion of the PSF is not obstructed even when the positional displacement of the opening portion occurs.

In the confocal optical system, a high resolution in a focusing direction and a high in-plane resolution are advantages compared to a related art optical system. Accordingly, in the confocal optical inspection apparatus 100, the opening member 170 illustrated in FIG. 8, provided on the light-receiving side, further increases such a resolution. Meanwhile, when the resolution in the focusing direction is not necessary, the opening member on the light-receiving side may be omitted in the confocal optical inspection apparatus 100 as illustrated in FIG. 1. Even if the opening member on the light-receiving side is omitted, the in-plane resolution is ensured using the above-described PSF.

In addition, the information processor 160 (particularly, a function of the correction processor 164) according to the above-described exemplary embodiment may also be implemented by a computer program for causing hardware such as a CPU, a ROM, or a RAM, which is built into an information processing device such as a computer, to work. The computer program may be provided by a storage medium having embodied thereon the computer program.

As described above, according to exemplary embodiments, there are provided a confocal optical inspection apparatus and a confocal optical inspection method capable of acquiring information about an object with a higher level of accuracy in consideration of distortion of an optical transmission path.

While the inventive concept has been particularly shown and described with reference to exemplary embodiments thereof, it will be understood that various changes in form and details may be made therein without departing from the spirit and scope of the following claims.

What is claimed is:

1. A confocal optical inspection apparatus that acquires a confocal image of an object and inspects the object, the confocal optical inspection apparatus comprising:
a light source that is configured to emit illumination light;
a first opening member that is configured to divide the illumination light emitted from the light source into a plurality of illumination light beams, the first opening member having a plurality of openings;
an imaging device that is configured to acquire an image according to the respective illumination light beams reflected by the object; and
an information processor that is configured to acquire a corrected confocal image in which distortion of an optical transmission path of the confocal optical inspection apparatus is removed from a time delayed integration (TDI) image obtained by a TDI operation of the imaging device, using a pre-measured point spread function (PSF) indicating optical characteristics of the confocal optical inspection apparatus.

2. The confocal optical inspection apparatus of claim 1,
wherein the PSF, the TDI image, and the corrected confocal image of the object, which is an original image, satisfy
g(x)=Σᵢ^{N}p(x−xᵢ)f(xᵢ) (FORMULA 1)
wherein, g(x) denotes the TDI image, p(x) denotes the PSF, f(x) denotes the corrected confocal image, x denotes a pixel position of the TDI image, and i denotes a value of 0 to N, and
wherein the information processor calculates an inverse matrix of the PSF to acquire the corrected confocal image which is an estimated image of the confocal image.

3. The confocal optical inspection apparatus of claim 1, wherein the PSF is acquired by imaging the object in a state where the object is stopped.

4. The confocal optical inspection apparatus of claim 1,
wherein the openings of the first opening member are formed in a lattice shape such that each opening has a shift amount in a first direction which is a scanning direction of the object and a shift amount in a second direction perpendicular to the scanning direction, and
wherein the shift amount of the opening in the second direction is an integer multiple of a pixel size of the TDI image.

5. The confocal optical inspection apparatus of claim 4, wherein each of the openings of the first opening member is a pinhole.

6. The confocal optical inspection apparatus of claim 1, further comprising a second opening member having a plurality of openings transmitting reflected light from the object,
wherein each of the openings of the second opening member is formed such that a length of the opening in an insertion and extraction direction, in which the second opening member is inserted into and extracted from the confocal optical inspection apparatus, is larger than a length of the opening in a direction perpendicular to the insertion and extraction direction.

7. The confocal optical inspection apparatus of claim 6, wherein the second opening member is capable of being inserted or extracted in the second direction perpendicular to the scanning direction of the object.

8. A confocal optical inspection method of acquiring a confocal image of an object to inspect the object, the confocal optical inspection method comprising:
acquiring a point spread function (PSF) indicating characteristics of an optical system of a confocal optical inspection apparatus; and
acquiring a corrected confocal image in which distortion of an optical transmission path of the confocal optical inspection apparatus is removed from a time delayed integration (TDI) image obtained by a TDI operation of an imaging device of the confocal optical inspection apparatus, by using the PSF.

9. A confocal optical inspection apparatus comprising:
a time delay integration (TDI) camera that acquires an image from light reflected by an object;
a light source that emits illumination light;
a pinhole member that is provided in an optical transmission path from the light source to the TDI camera, and comprises a plurality of pinholes that divide the illumination light into a plurality of illumination light beams for illuminating the object; and
an information processor that is configured to acquire a point spread function (PSF) indicating an optical characteristic of the optical transmission path from the image acquired by the TDI camera when the object is stationary, produces, using the acquired PSF, a corrected confocal image in which distortion from the optical transmission path is removed from a TDI image acquired by a TDI operation of the TDI camera when the object is moving, and outputs the corrected confocal image.

10. The confocal optical inspection apparatus of claim 9, further comprising one or more relay lenses, wherein the one or more relay lenses are positioned in the optical transmission path.

11. The confocal optical inspection apparatus of claim 9, wherein the pinhole member further comprises a microlens array that focuses the illumination light on the pinholes.

12. The confocal optical inspection apparatus of claim 9, further comprising an object lens and a beam splitter, wherein the object lens and the beam splitter are provided in the optical transmission path.

13. The confocal optical inspection apparatus of claim 10, further comprising an object lens and a beam splitter, wherein the object lens and the beam splitter are provided in the optical transmission path.

14. The confocal optical inspection apparatus of claim 9, wherein the pinholes formed in a lattice shape in the pinhole member such that each opening is shifted by a shift amount in a first direction which is a scanning direction of the object and by a shift amount in a second direction perpendicular to the scanning direction, and
wherein the shift amount of the pinholes in the second direction is an integer multiple of a pixel size of the TDI image.

15. The confocal optical inspection apparatus of claim 9, further comprising an opening member that comprises a plurality of openings and that is positioned in the optical transmission path downstream from the pinhole member.

16. The confocal optical inspection apparatus of claim 15, further comprising an opening member that comprises a plurality of slits and that is positioned in the optical transmission path downstream from the pinhole member,
wherein each of the slits is formed such that a length of the slit in the second direction is larger than a length of the slit in the first direction.

17. The confocal optical inspection apparatus of claim 9,
wherein the PSF, the TDI image, and the corrected confocal image satisfy
g(x)=Σᵢ^{N}p(x−xᵢ)f(xᵢ) (FORMULA 1)
wherein, g(x) denotes the TDI image, p(x) denotes the PSF, f(x) denotes the corrected confocal image, x denotes a pixel position of the TDI image, and i denotes a value of 0 to N.

18. The confocal optical inspection apparatus of claim 17, wherein the information processor calculates an inverse matrix of the PSF to produce the corrected confocal image.
